(19) United States
(12) Patent Application Publication
(10) Pub. No.: US 2007/0070978 A1
(43) Pub. Date: Mar. 29, 2007

(54) Accessing content at a geographical location

(75) Inventors: David A. Bell, LONDON (GB); Stuart Butterfield, Watlington (GB); David E. Penna, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/576,391

(22) PCT Filed: Oct. 15, 2004
(86) PCT No.: PCT/IB04/52108

§ 371 Date: Apr. 20, 2006

(30) Foreign Application Priority Data
Oct. 23, 2003 (GB) 0324696.4

(51) Int. Cl. H04L 12/66

(52) U.S. Cl. 370/352

(57) ABSTRACT

A method for accessing content according to a location within a defined geographical area. The area is defined (104) by those areas covered by selected nodes of one or more networks. Data representing the identities of the selected nodes or of the defined geographical area is then provided (110) to authorised receivers, for example via a Smart Card or the Internet. Corresponding data is broadcast (112) to locations within the defined geographical area The receiver at such a location permits access (124) to content based on a comparison (122) of the provided and received data. The content may be stored locally on physical media or obtained remotely via a network.

The present invention relates to a method and system for accessing content, in particular according to a location within a defined geographical area.

New generation mobile telephony services require additional radio spectrum bandwidth and regulators have identified an opportunity to make bandwidth available in the UHF spectrum (for UK, within UHF bands IV and V). It is proposed to cease transmission of terrestrial analogue PAL TV broadcast services in favour of digital TV broadcast services transmitted using one or more of the Digital Video Broadcasting (DVB) standards. One DVB standard, digital terrestrial television DTT, has the advantage of having well defined geographical coverage but will take time and investment to reach the equivalent population currently served by analogue PAL TV broadcast services. Conversely, digital satellite broadcasting (for example via the SES-Astra system) economically provides coverage to (accessibility by) the entire intended audience but with a lack of precision with respect to the served geographical region, for example due to the need to maintain an adequate link budget. It is politically and commercially important to maintain (and if possible enhance) existing business models and audience coverage as presently provided by analogue PAL TV broadcast services, for example national and regionalised programming and services.

US Patent Application 2002/54777 discloses a system for authenticating the location of content players, wherein a content player determines its physical location on its own. After comparing that determined location with access criteria, the device can decide whether or not it is authorised. A disadvantage is that the access criteria for a particular player must enumerate all locations which are authorised or unauthorised; the citation acknowledges this stating that the access criteria may comprise a relatively long list of authorised and/or unauthorised locations or regions. It is inefficient to use location-based access criteria to define regions for which a content player is authorised or unauthorised. Clearly, a long list also has an impact on data transfer requirements to distribute access criteria to each and every content player, and is further exacerbated where changes are required to be made to such access criteria. US200210154777 further discloses a content processing device comprising a descrambler, a means for autonomously determining location and a processor. In a particular embodiment it is disclosed that the means for autonomously determining location comprises a cellular receiver, which receives cellular phone signals to determine a location of a content processing device. A method using the cellular phone signals is not disclosed.

It is an object of the invention to improve on the known art.

In accordance with the present invention there is provided a method for accessing content according to a location within a geographical area of a plurality of geographical areas, wherein the content is provided within the plurality of geographical areas, the method being independent of determining the location and comprising:
defining a first geographical area;
determining first data in relation to the first geographical area;
determining second data in dependence on first data;
providing first data to a receiver;
sending second data to locations within the first geographical area;

and, for the receiver at a location within the first geographical area:
accessing first data;
receiving second data;
comparing second data with first data; and
accessing content in dependence on the results of the comparison.

The method defines a geographical area using any suitable geographically related criteria. Although the defined geographical area may be considered to contain a set of locations, it is defined without requiring the determination of any of those locations. A desired geographical area can be defined by selecting a set of sub-areas, wherein the geographical coverage of each sub-area being already known. The sub-areas may be selected so that the geographical area is a single contiguous area or comprises several distinct areas. A defined geographical area may overlap another defined geographical area, for example one or more sub-areas are common to each area. The geographical area may be defined to meet content provider requirements, user requirements or other requirements; for example for regionalised programming within a larger state, or to allow a user the ability to geographically roam. Advantageously, it has been recognised that existing data distribution networks can be used to define suitable geographical areas. Such networks comprise one or more data transmission nodes, each node serving a defined geographical area (cell). Selection of suitable cells of one or more such networks can be used to define a requisite geographical area. A network with many small area cells permits the definition of a high resolution geographical area.

First data may comprise either information associated with the definition of a geographical area (for example a set of identifiers associated with the cells of a network) or alternatively a data value identifying a defined geographical area. In the latter case, advantageously the quantity of first data to be distributed is minimised thereby improving efficiency; furthermore, such a data format allows a location to simultaneously belong to more than one defined geographical area. A further advantage is that a receiver outside the defined geographical area could (typically as an exception) access content for that defined geographical area by being provided with the appropriate data value. Preferably the first data is provided to the receiver by means of a data carrier which is independent of that used for the second data. Advantageously, the first data is provided utilising existing distribution channels used to communicate with individual receivers, for example a Smart Card, a network used to distribute content, or the Internet.

Second data is determined in dependence on first data and may comprise either information associated with at least one location within the defined geographical area (for example an identifier within the set of identifiers associated with the cells of a network) or the aforementioned data value (or a portion thereof). Second data is distributed only to locations within the defined geographical area, that is, not to locations in another defined geographical area. Advantageously, the coverage area of a data transmission node of a data distribution network enables second data to be sent to locations within the coverage area, and to only those locations. Preferably, the data distribution network supports broadcasting of second data from its data transmission nodes. In this way locations within the coverage area of a node can be simultaneously addressed allowing for real-time updates and improved efficiency of transmission of second data. For a defined geographical area comprising more than one node, access to content by receivers located in the defined geographical area may be adapted in real-time by suspending (and subsequently resuming) the broadcasting of second data from one or more of the nodes, without the need to re-define and provide first data to the receivers.

A receiver located within the defined geographical area accesses and preferably stores the first data. A comparison is then made between first data and any second data received at the location. Content is accessed conditionally on the results of the comparison, for example by inhibiting access where no second data is received, or where second data is received but does not correspond in some pre-determined way with the first data. Typically, access to content is permitted when second data corresponds with first data, for example a matching GSM Cell_ID, or corresponding data value. For added security, first data and/or second data is preferably encrypted prior to distribution and decrypted in the receiver using any suitable means as may be available or provided; further details of such means are outside the scope of the present invention and will not be further discussed herein.

According to another aspect of the present invention there is provided a system for accessing content at a location within a geographical area of a plurality of geographical areas, the system comprising:
a server operable to:
   define a first geographical area;
   determine first data in relation to the first geographical area; and
   determine second data in dependence on first data;
means to provide first data to a receiver;
a first network operable to send second data to locations within the first geographical area; and
   a receiver operable to:
   access first data;
   receive second data;
   compare second data with first data; and
   access content in dependence on the results of the comparison.

First data is provided to receivers by means such as Smart Cards distributed via mail and retailers, by download from a server on the Internet, by data channel over a network distributing content, or by any other suitable method.

Preferably existing networks are used to send second data, for example those networks used for terrestrial broadcast TV, terrestrial broadcast radio and terrestrial mobile (cellular) telephone, or any combination thereof. Advantageously, as second data is in general common to more than one served location within a defined geographical area, this enables these networks to carry second data with minimal adverse impact on their primary functions; in some cases, the second data might even comprise data related to the network itself resulting in zero additional data overhead for the network. The choice of which network or networks to use to send second data will depend for example on the requirements such as the defined geographical area, the resolution (coverage) of nodes covering that area and whether the network fully covers the area. In the case where terrestrial mobile telephone cell network is used to send second data, preferably the mechanism used is Cell Broadcast, or any equivalent such mechanism, enabling a transmitter (basestation) to broadcast data to all receivers located within the coverage area (cell) of the transmitter.

According to a further aspect of the present invention there is provided a receiver for use in the system as described herein, comprising:
an interface operable to access first data;
a first tuner operable to receive second data;
processor operable to:
   compare second data with first data; and
   access content in dependence on the results of the comparison.

First data is accessed by the receiver by means of a data carrier independent of that used for the second data. Preferably, the receiver comprises a store to store first data. The receiver may access first data via an interface to any suitable data carrier including a Smart Card or other physical media, a modem for Internet download, or a network (including a content delivery network). The content may be obtained locally (for example from optical or magnetic media) and/or from a network by means of a tuner, access to the content being dependent on the results of the comparison of first data and second data.

Advantages of the invention are that access to generally distributed content (for example via satellite, physical media and the like) is controlled in accordance with receipt of access data distributed to a precisely defined geographical area. The method exploits the geographical characteristics of existing data distribution networks to achieve the required precision whilst also minimising any additional data transmission requirement of such networks; in particular cases the transmission requirement is zero.

Embodiments of the invention will now be described, by way of example only, with reference to the accompanying drawings in which:

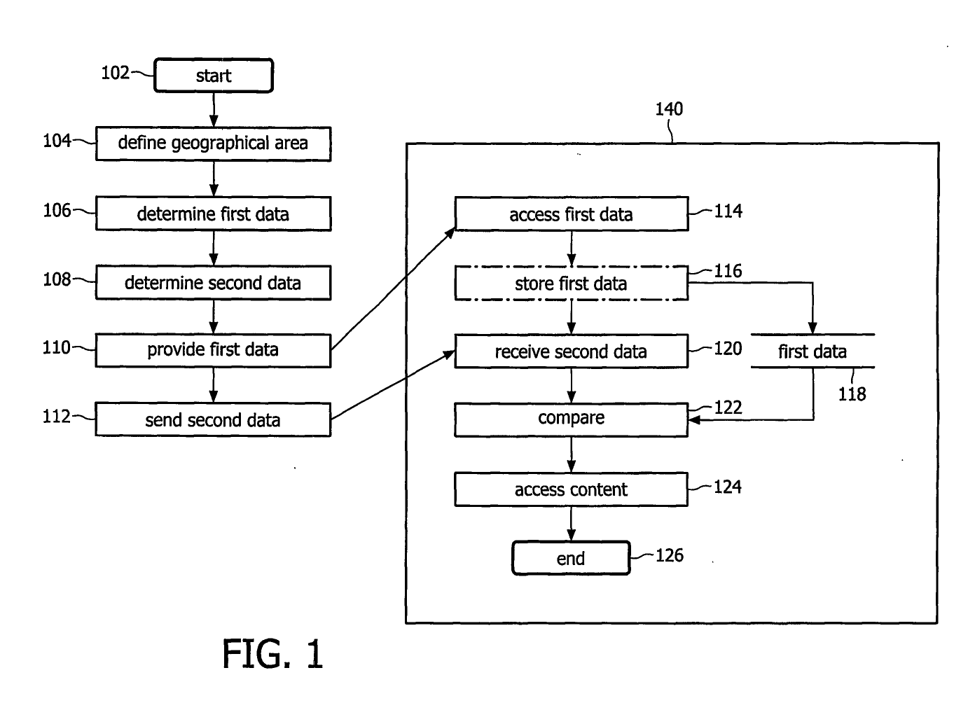

FIG. 1 is a flow diagram of a method for accessing content at a location within a geographical area;

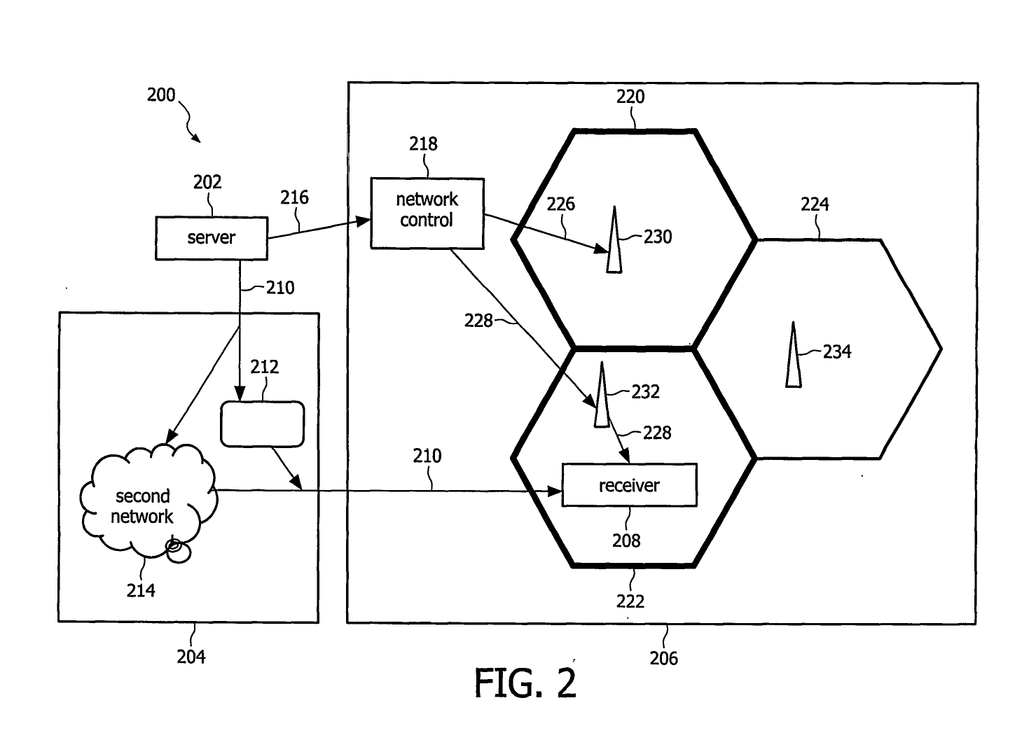

FIG. 2 is a schematic of a system for accessing content at a location within a geographical area; and

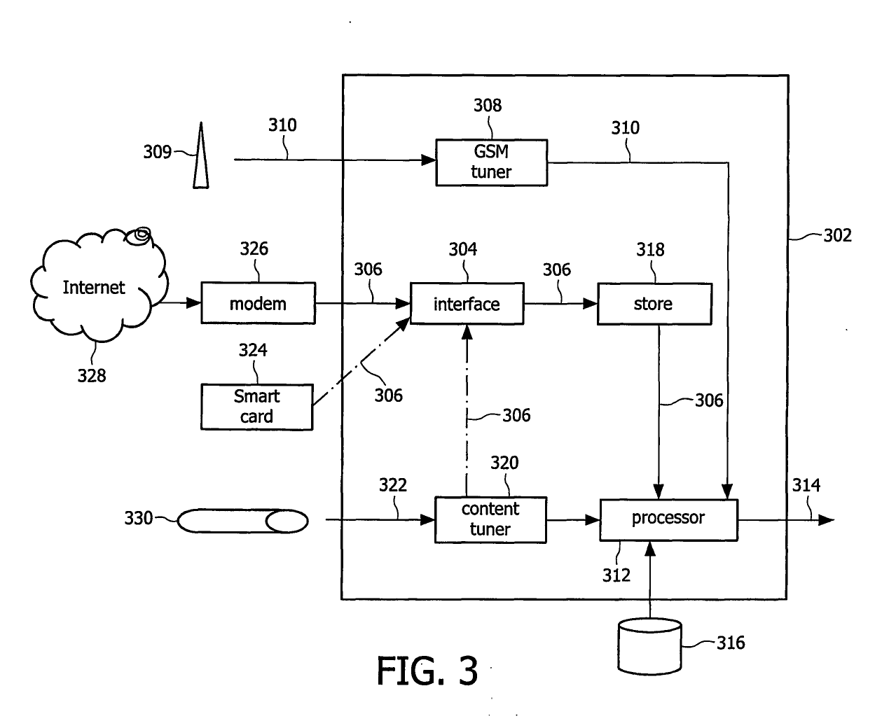

FIG. 3 is a schematic of a receiver used in the system of FIG. 2.

In relation to the description herein, the term ‘location’ refers to a geographical position which is typically to the resolution of a building such as a persons residence. The term ‘geographical area’ generally refers to one or more contiguous areas of terrain each containing a number of locations.

FIG. 1 shows a flow diagram of a method for accessing content at a location within a geographical area. The method starts at 102 and then defines 104 a geographical area. The defined geographical area specifies a particular area of terrain by reference to which access to content may be determined. Although the defined geographical area may be considered to contain a set of locations, it is defined without requiring the specific determination of any of those locations. In a preferred embodiment, the geographical area is defined with reference to the geographical coverage of one or more existing data distribution networks. Such networks typically comprise one or more data transmission nodes, each node operable to cover a particular geographical area. In practice, a geographical area can be defined by selecting suitable nodes of one or more networks which together cover, and preferably only cover, a desired geographical area. As an example, presuming the requirement is to define the Greater London area (in the UK) for regional programming purposes; general coverage could be obtained using terrestrial broadcast TV transmitters, plus additional fill-in using selected terrestrial mobile telephone cells for portions of the defined geographical area not covered by the terrestrial broadcast TV transmitter. Alternatively, in the case where the coverage needs to be more precisely defined (for example, to exclude receivers near to, but outside, the Greater London region), nodes with more precise coverage might be used such as those of a terrestrial mobile telephone cellular network, by using only those mobile telephone network cells which only cover the Greater London region. Clearly, an already defined geographical area can be adapted by adding or removing nodes of network(s) used to define the area.

In addition, or alternatively, a geographical area can be defined with reference to the receiver (user), for example to specify a particular area of terrain the locations within which a particular receiver is authorised to access content. For example, a receiver (user) may wish to access content say at home and at a friend's home; a geographical area can be defined for that user by selecting suitable nodes of one or more networks to cover at least those homes.

The method then determines 106 first data in relation to the defined geographical area. First data comprises information associated with the definition of the geographical area, for example the identities of the selected nodes of the network(s), or a data value. In the latter case, the data value might be associated with a conditional access means in the receiver, for example the data value is an encrypted control word, which control word is used to descramble the content. Such means, being well known to the person skilled in the art, are outside the scope of the present invention will only be referred to rather than further described herein. The method then determines 108 second data in dependence on first data. Second data comprises information associated with at least one location within the defined geographical area and is intended to be sent to locations within the defined geographical area. For a given set of network nodes covering the defined geographical area, second data may be common to the nodes, or it may be specific to particular nodes of the set. By way of example, where first data comprises the identities of the selected nodes of the network(s), second data comprises the same identities, wherein for a particular node the second data comprises just the identity corresponding to that node. In this way second data received at the receiver location comprises information associated with locations covered by the particular node, rather than for all locations of the defined geographical area. An alternative example is where first data comprises a data value and second data received at any location within the defined geographical area would also comprise the same data value (or a portion thereof).

The method then provides 110 first data to a receiver, for example by including first data within physical media (for example, read from Smart card, disk, CD or the like) sent to the receiver; or received via a network including the Internet; or via the network or media containing the content to be accessed. Second data is sent 112 to locations within the defined geographical area and substantially only to those locations (the precision by which this is achieved depends on coverage characteristics of nodes of the network(s) used to send the second data, as discussed above). For added security, the second data may be encrypted prior to being sent and decrypted after being received. Suitable networks to send second data include: terrestrial TV broadcast (for example via the teletext service, or a DTT data channel), terrestrial radio broadcast (for example within RDS or a DAB data channel) and cable networks. A preferred network to send second data is a terrestrial mobile cellular telephone network, such a network offers precise geographical coverage and efficiency through the ability to broadcast data to locations within cells of the network (for example using GSM Cell Broadcast).

For a receiver at a location 140 within the defined geographical area, the method then accesses 114 first data provided by physical media or network, as described above. Depending on how first data is provided, it may then be stored 116 in store 118. Second data is received 120 and compared 122 with first data. The comparison generally determines if first data comprises a value and second data comprises a corresponding component of that value; for example first data includes a set of identities of network nodes and one of these matches the identity of a network node received as second data. One such example is where first data comprises the Cell_IDs of cells of a terrestrial mobile telephone network covering the defined geographical area, wherein each cell broadcasts its respective Cell_ID representing the second data for that particular cell. Another example is where first data and second data are the same data value. Various other schemes based on data values can be devised by the skilled person. Where the comparison is successful, the content is accessed 124. The content may be available locally to the receiver on any suitable media (optical, magnetic, and the like) or via a network, including broadcast and the Internet. The method ends at 126.

FIG. 2 shows a schematic of a system for accessing content at a location within a geographical area. The system, shown generally at 200, comprises a server 202, means 204 to provide first data to a receiver 208, and a network 206. The server may reside at a content publisher or provider or other entity that wishes to regulate access to the content. The server is configured to define a geographical area, for example by selecting nodes of one or more (preferably existing) networks to define a desired geographical area. In the example of FIG. 2, a network is used comprising three nodes (transmitters) 230, 232, 234 with respective geographic coverage areas (cells) shown at 220, 222, 224. Clearly, in practice such a network might have many more nodes, each node having coverage according to terrain and propagation criteria. In the example, a desired geographical area is covered by areas 220, 222 as indicated by the bold outlining. Note, the actual desired geographical area could be less than the combined area of 220 and 224. In the example, the combined area of 220 and 224 provides the closest approximation—use of nodes with smaller coverage areas could improve the match between the desired and the defined geographical area. Nodes 230, 232, 234 could belong to any suitable network or to different networks (e.g. 230 could be a terrestrial broadcast TV or radio transmitter and 232 a community cable TV headend). Coverage areas of adjacent nodes preferably abut (as shown) allowing precision in the coverage of the defined geographical area; however, networks comprising nodes with less precise coverage areas (for example such that coverage areas of adjacent nodes overlap to an extent) can be used with the method of the invention provided the resulting (less precise) defined geographical area is adequate for the intended end purpose; as might be the case for example when defining a geographical area corresponding to the UK.

For the purpose of illustration, the network 206 of FIG. 2 comprises nodes of a terrestrial mobile cellular telephone network. The defined geographical area is represented by coverage areas 220, 222 of nodes 230, 232. As a result, first data 210 is determined to comprise the identifiers of nodes 230 and 232, denoted Cell_ID(230) and Cell_ID(232). This first data 210 is then forwarded to means 204 comprising a Smart Card 212 or a network 214 used to provide first data 210 to receiver 208. The receiver may access the first data by reading the Smart Card 212 or by downloading from a server (or server 202) via the network 214. In place of the Smart Card 212 any physical optical or magnetic media could be used; the network 214 can be any network including the Internet and a network used for distributing content. Data 216 is sent by the server to network controller 218 of network 206. In the example, data 216 could comprise a copy of first data or simply a code or instruction identifying the defined geographical area to network 206. In either case, network controller 218 parses data 216 and forwards instructions 226, 228 respectively to nodes 230, 232 instructing each node to issue a respective Cell Broadcast (CB) message 226, 228 comprising the relevant Cell_ID, namely Cell_ID(230) and Cell_ID(232). The CB messages are receivable by receivers at locations within the coverage area comprising 220 and 222. Receiver 208 is at an unspecified location within coverage area 222 of node 232 and receives second data in the form of CB message 228 comprising Cell_ID(232). Receiver then compares the received second data with first data accessed and finds a match thereby allowing access to content. Other formats for first and second data and the comparison thereof have been described above. In the above example, if network 206 in any case outputs Cell_ID data for other purposes, then there is no need to forward data 216 to network 206 thereby further improving efficiency and simplifying implementation.

FIG. 3 shows a schematic of a receiver used in the system of FIG. 2. The receiver 302 comprises an interface 304 connected to a modem 326 to download data 306 from a server (not shown) on the Internet 328. As alternatives (denoted by the dotted lines) interface 304 may read data 306 from a Smart Card 324 or via a tuner 320 used to receive content 322 such as a TV channel from cable network 330. Interface 304 forwards the received data 306 to store 318. The receiver also comprises a GSM tuner 308 which receives data 310 from GSM network 309; other networks can be used, as discussed above. Data 310 is forwarded to processor 312 which compares received data 310 with stored data 306. According to the results of the comparison, the processor accesses content 322 (received from network 330, or from local storage 316 such as optical or magnetic media); permitted content is output from the receiver at 314.

The foregoing method and implementation are presented by way of example only and represent a selection of a range of methods and implementations that can readily be identified by a person skilled in the art to exploit the advantages of the present invention.

In the description above and with reference to FIG. 1 there is disclosed a method for accessing content according to a location within a defined geographical area. The area is defined by the those areas covered by selected nodes of one or more networks. Data representing the identities of the selected nodes or of the defined geographical area is then provided to authorised receivers, for example via a Smart Card or the Internet. Corresponding data is broadcast to locations within the defined geographical area. The receiver at such a location permits access to content based on a comparison of the provided and received data. The content may be stored locally on physical media or obtained remotely via a network.

1. A method for accessing content according to a location within a geographical area of a plurality of geographical areas, wherein the content is provided within the plurality of geographical areas, the method being independent of determining the location and comprising:
defining (104) a first geographical area;
determining (106) first data in relation to the first geographical area;
determining (108) second data in dependence on first data;
providing (110) first data to a receiver;
sending (112) second data to locations within the first geographical area;
and, for the receiver at a location within the first geographical area:
accessing (114) first data;
receiving (120) second data;
comparing (122) second data with first data; and
accessing (124) content in dependence on the results of the comparison.

2. A method as claimed in claim 1, further comprising, following the accessing step, storing (116) first data.

3. A method as claimed in claim 1, wherein sending second data comprises broadcasting said data.

4. A method as claimed in claim 1, wherein the first data comprises information associated with the definition of the first geographical area and the second data comprises information associated with at least one location within the first geographical area.

5. A method as claimed in claim 4, wherein the first data comprises at least one GSM Cell_ID and the second data comprises a GSM Cell_ID matching a GSM Cell_ID of the first data.

6. A method as claimed in claim 1, wherein there is a correspondence between first data and second data.

7. A method as claimed in claim 1, wherein the second data is encrypted prior to being sent and decrypted after being received.

8. A system (200) for accessing content at a location within a geographical area of a plurality of geographical areas, the system comprising:
a server (202) operable to:
define a first geographical area;
determine first data in relation to the first geographical area; and
determine second data in dependence on first data;
means (204) to provide first data to a receiver;
a first network (206) operable to send second data to locations within the first geographical area; and
a receiver (208) operable to:
access first data;
receive second data;
compare second data with first data; and
access content in dependence on the results of the comparison.

9. A system as claimed in claim 8, wherein the first network comprises one or more data transmission nodes (230, 232, 234), each node operable to cover a respective geographical area (220, 222, 224.)

10. A system as claimed in claim 8, wherein the first network is that used for terrestrial broadcast television services.

11. A system as claimed in claim 8, wherein the first network is that used for terrestrial broadcast radio services.

12. A system as claimed in claim 8, wherein the first network is that used for terrestrial mobile telephony services.

13. A system as claimed in claim 12, wherein the terrestrial mobile telephony data service is Cell Broadcast.

14. A system as claimed in claim 8, wherein the means to provide first data to a receiver comprises a Smart Card (212) containing the first data.

15. A system as claimed in claim 8, wherein the means to provide first data to a receiver comprises a second network (214) operable to send first data to the receiver.

16. A system as claimed in claim 15, wherein the second network is further operable to send content to the receiver.

17. A receiver (302) for use in the system as claimed in any of claims 8 to 16, comprising:
an interface (304) operable to access first data;
a first tuner (308) operable to receive second data;
processor (312) operable to:
compare second data with first data; and
access content in dependence on the results of the comparison.

18. A receiver as claimed in claim 17, further comprising a store (318) and wherein the processor is further operable to store accessed first data.

19. A receiver as claimed in claim 17 further comprising a second tuner (320) operable to receiver constant.

20. A receiver as claimed in claim 17, wherein the interface is operable to read a Smart Card.

21. A receiver as claimed in claim 17, wherein the interface is operable to communicate with a modem (326).

22. A receiver as claimed in claim 19, wherein the processor is further operable to access first data via the second tuner.
